(19) United States
(12) Patent Application Publication
(10) Pub. No.: US 2016/0019867 A1
(43) Pub. Date: Jan. 21, 2016

(54) METHOD OF PROVIDING MAP SERVICE, DISPLAY CONTROL METHOD, AND COMPUTER PROGRAMS FOR PERFORMING THE METHODS

(71) Applicant: NAVER CORPORATION, Seongnam-si (KR)

(72) Inventor: Ki Young Yun, Seongnam-si (KR)

(21) Appl. No.: 14/797,750

(22) Filed: Jul. 13, 2015

(30) Foreign Application Priority Data
Jul. 16, 2014 (KR) 10-2014-0089895

(51) Int. Cl. G09G 5/377; G06F 3/0484; G06F 3/0486; G06F 3/0481

(52) U.S. Cl. CPC G09G 5/377; G06F 3/0481; G06F 3/04842; G06F 3/04845; G06F 3/04817; G06F 3/0486

(57) ABSTRACT

A method of providing a map service includes outputting a map on which at least one point of interest is registered, providing a screen region to a user terminal, wherein the screen region is at least a region of the map to be displayed on a screen of the user terminal, and generating non-screen region information by processing information regarding the at least one point of interest included in a non-screen region, and providing the user terminal with the non-screen region information such that the non-screen region information is displayed in the screen region, wherein the non-screen region is a region of the map not including the screen region.

### CROSS-REFERENCE TO RELATED APPLICATION

This application claims the benefit of Korean Patent Application No. 10-2014-0089895, filed on Jul. 16, 2014, in the Korean Intellectual Property Office, the disclosure of which is incorporated herein in its entirety by reference.

### BACKGROUND

1. Field

One or more exemplary embodiments of the present invention relate to a method of providing a map service, a display control method, and computer programs causing a computer to perform the methods.

2. Description of the Related Art

With advancements in electronic communication technology, users have become able to use various terminal functions. The term “terminal” means a personal computer (PC) or a portable terminal. Such terminals are highly available and many users are quite familiar with installing various programs therein, deleting programs therefrom, and directly accessing the Internet using the terminals via the wireless Internet.

The current location of a portable terminal including a location receiver (e.g., a GPS receiver) or a PC accessing the Internet may be detected. Thus, location-based services, such as application programs associated with a map, have been actively developed and used.

Since a display unit of a terminal has a small size, all regions of a map may not be displayed on the display unit at one time. In this case, a user would have difficulties in determining various items in a region of the map that is not displayed on a screen.

The information disclosed in this Background section was already known to the inventors before achieving the inventive concept or is technical information acquired in the process of achieving the inventive concept. Therefore, it may contain information that does not form the prior art that is already known to the public in this country.

### SUMMARY

One or more exemplary embodiments of the present invention include a map service providing method, a display control method, and a computer program causing a computer to perform the method.

One or more exemplary embodiments include a map service providing method capable of displaying information regarding a region of a map, which is not displayed on a screen, on the screen to increase user convenience, a display control method, and a computer program causing a computer to perform the methods.

Additional aspects will be set forth in part in the description which follows and, in part, will be apparent from the description, or may be learned by practice of the presented embodiments.

According to one or more exemplary embodiments of the present invention, a method of providing a map service includes outputting a map on which at least one point of interest is registered; providing a screen region to a user terminal, wherein the screen region is at least a region of the map to be displayed on a screen of the user terminal; and generating non-screen region information by processing information regarding the at least one point of interest included in a non-screen region, and providing the user terminal with the non-screen region information such that the non-screen region information is displayed in the screen region, wherein the non-screen region is a region of the map not including the screen region.

According to one or more exemplary embodiments, a display control method includes receiving a map on which at least one point of interest is registered; determining at least a region of the map as a screen region; and generating non-screen region information by processing information regarding the at least one point of interest included in a non-screen region, wherein the non-screen region is a region of the map not including the screen region; and displaying the screen region and the non-screen region information in the screen region.

According to one or more exemplary embodiments, there is provided a computer program stored in a recording medium to cause a computer to perform the above methods in conjunction with hardware.

Other aspects, features, and advantages of the inventive concept will be apparent from the following detailed description and claims, taken in conduction with the accompanying drawings.

Such general and specific aspects of the inventive concept may be performed using a system, a method, a computer program, or a combination thereof.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating the structure of a map service providing system according to an exemplary embodiment;

FIG. 2 is a block diagram of a map service providing apparatus included in a service providing server of FIG. 1 according to an exemplary embodiment;

FIG. 3 is a flowchart of a map service providing method according to an exemplary embodiment;

FIG. 4 is a block diagram of a display control device included in a user terminal of FIG. 1 according to an exemplary embodiment;

FIG. 5 is a flowchart of a display control method according to an exemplary embodiment; and

FIGS. 6 to 11 illustrate a map provided from a map service providing system and examples of a screen region of a map according to exemplary embodiments.

### DETAILED DESCRIPTION

Reference will now be made in detail to the embodiments of the present invention, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms ‘first’, ‘second’, ‘third’, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept. It will be further understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof. In the drawings, the lengths and sizes of layers and regions may be exaggerated for clarity. For example, the sizes and thicknesses of the elements shown in the drawings are arbitrarily illustrated for convenience of explanation and the inventive concept is not thus limited thereto.

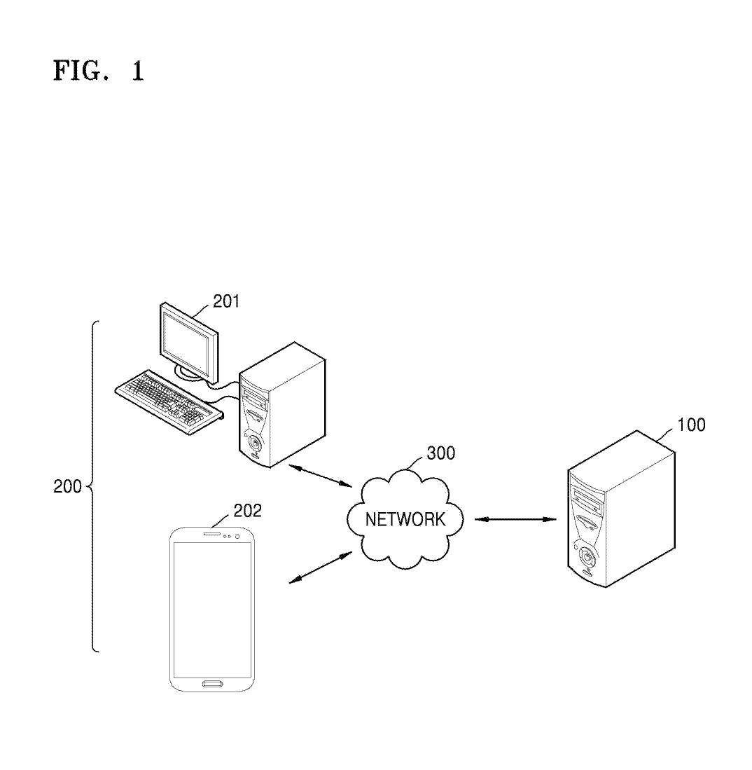

FIG. 1 is a diagram illustrating the structure of a map service providing system according to an exemplary embodiment.

Referring to FIG. 1, the map service providing system according to an exemplary embodiment includes a service providing server 100, a plurality of user terminals 200, and a network 300 connecting the plurality of user terminals 200 and the service providing server 100.

A map service according to an exemplary embodiment provides, for example, a map including a search result corresponding to a search request input by a user. For example, the map service providing system detects places of interest corresponding to a request input by a user and provides a map including the detected places of interest. The map is displayed on a screen of a user terminal 200 of the user who input the request. At least a portion of the map (hereinafter referred to as ‘screen region’) may be displayed on the screen, and information regarding the places of interest included in the remaining region of the map that is not displayed on the screen is displayed in the screen region.

Referring to FIG. 1, the user terminals 200 are preferably communication terminals via which a web service may be used in a wired/wireless communication environment. Here, the user terminals 200 may be users' personal computer (PC) 201 or portable terminal 202. Although FIG. 1 illustrates that the portable terminal 202 as a smart phone, the inventive concept is not limited thereto and any terminal in which an application having a web browsing function is installed may be employed as the portable terminal 202 as described above.

Each of the user terminals 200 includes a display unit configured to display a screen, and an input device via which data is received from a user. Examples of the input device include a keyboard, a mouse, a track ball, a microphone, a button, a touch panel, etc. but are not limited thereto.

The network 300 connects the user terminals 200 and the service providing server 100. For example, the network 300 provides an access path via which the user terminals 200 access the service providing server 100 to transmit packet data to or receive packet data from the service providing server 100.

The service providing server 100 receives requests to provide maps from the user terminals 200 and provides the user terminals 200 with maps including search results corresponding to the requests. Although not shown, according to an exemplary embodiment, the service providing server 100 includes a memory, an input/output (I/O) unit, a program storage unit, a controller, etc.

The inventive concept of the present invention may be realized in various embodiments. For example, according to a first embodiment, a map service providing apparatus 110 included in the service providing server 100 generates a screen region and a non-screen region using a map corresponding to a search request from any of the user terminals 200 and provide them to the requesting user terminal 200.

According to a second embodiment, a display control device 120 included in each of the user terminals 200 receives a map from the service providing server 100, determines a screen region to be displayed on a screen, based on the map, and controls a display unit of the user terminals 200 to display the screen region and a non-screen region, based on the screen region.

The first and second embodiments will be described in detail below. The following description of the first embodiment is also applicable to the second embodiment and vice versa. Thus, same parts of the first and second embodiments may be described once with respect to the first or second embodiment.

### First embodiment

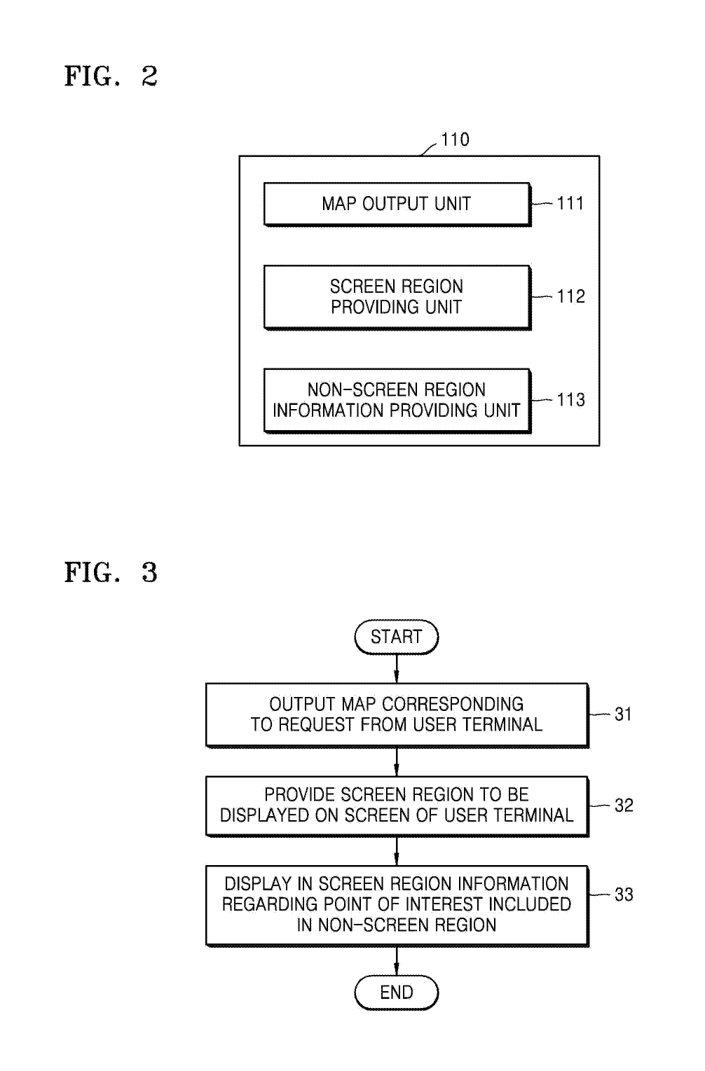

FIG. 2 is a block diagram of the map service providing apparatus 110 included in the service providing server 100 of FIG. 1 according to an exemplary embodiment.

According to the exemplary embodiment, the map service providing apparatus 110 may correspond to or include at least one processor. Thus, the map service providing apparatus 110 may be driven while being included in another hardware device such as a microprocessor or a general-purpose computer system, and may be installed in each of the user terminals 200.

Only some elements of the map service providing apparatus 110 related to the present embodiment are illustrated in FIG. 2 to prevent features of the present embodiment from being obscure. It would be apparent to those of ordinary skill in the art that the map service providing apparatus 110 may further include other general elements.

Referring to FIG. 2, according to the exemplary embodiment, the map service providing apparatus 110 includes a map output unit 111, a screen region providing unit 112, and a non-screen region information providing unit 113. The map output unit 111, the screen region providing unit 112, and the non-screen region information providing unit 113 may be different functions performed by the processor and identified for purpose of illustration, but the present invention is not limited thereto. For example, the map output unit 111, the screen region providing unit 112, and the non-screen region information providing unit 113 may be separate physical components of the processor, and implemented by separate program codes, or they may be implemented by one integrated program code.

According to an exemplary embodiment, the map output unit 111 outputs a map on which at least one point of interest is registered. The at least one point of interest may be classified according to the types thereof. For example, when the at least one point of interest represents real estate on the market, the at least one point of interest may be categorized as monthly rent, a key-money deposit, and for sale, etc., according to the types thereof.

According to an exemplary embodiment, the screen region providing unit 112 provides the user terminal 200 requesting a search with a screen region which is at least a region of the entire map to be displayed on the screen of the user terminal 200.

The screen region may be specified according to various methods, e.g., a method of specifying the screen region using barycentric coordinates and a scale, a method of specifying the screen region using the coordinates of vertices, etc.

According to an exemplary embodiment, the non-screen region information providing unit 113 generates non-screen region information by processing information regarding a point of interest included in a non-screen region, which is a region of the map not including the screen region, and provides the non-screen region information to the user terminal 200. The non-screen region information may be displayed in the screen region.

The non-screen region information may be generated, based on at least one among the number, types, and locations of places of interest included in the non-screen region and the distances between the places of interest and the screen region. For example, the non-screen region information may include at least one of the number of places of interest included in the non-screen region and the distance between the screen region and a point of interest closest to the screen region among the places of interest included in the non-screen region. In one exemplary embodiment, the non-screen region information may include the number of places of interest and the distances between the places of interest and the screen region according to each of the types of the places of interest. For example, the non-screen region information may include at least one of the number of places of interest corresponding to each of real estate for rent on a monthly basis, real estate for rent on a key money basis, and real estate for sale; and the distance between the screen region and a point of interest most closest to the screen region among the places of interest corresponding to each of real estate for rent on a monthly basis, real estate for rent on a key money basis, and real estate for sale.

The non-screen region may be divided into a plurality of sub-regions according to a preset criterion. According to an exemplary embodiment, the non-screen region information providing unit 113 may generate a plurality of pieces of non-screen region information respectively corresponding to each of the plurality of sub-regions. The non-screen region information may be displayed on an edge of the screen region. A plurality of pieces of non-screen region information may be arranged and displayed along the edge of the screen region.

The locations of the plurality of pieces of non-screen region information may be determined by the sub-regions corresponding to the plurality of pieces of non-screen region information. For example, when the non-screen region is divided into sub-regions according to a radiation angle with respect to a center of the screen region, the plurality of pieces of non-screen region information corresponding to the sub-regions may be displayed on locations on the edge of the screen region corresponding to the sub-regions.

The plurality of pieces of non-screen region information may be displayed together with icons stored beforehand. For example, the plurality of pieces of non-screen region information may be displayed in the icons. The icons may be displayed, for example, to face the sub-regions so as to point the sub-regions. For example, icons may be provided to correspond to the sub-regions, and displayed in the form of arrows pointing the sub-regions.

The map service providing apparatus 110 may receive a move command instructing to move the screen region from the user terminal 200 displaying the screen region. When the move command is received, the screen region providing unit 112 according to an exemplary embodiment updates and provides the screen region according to the move command. For example, the screen region providing unit 112 may update the screen region to include a point of interest corresponding to non-screen region information selected according to the move command and then provide the updated screen region. A plurality of places of interest may correspond to the non-screen region information selected according to the move command. In this case, the screen region providing unit 112 updates the screen region to include all the plurality of places of interest, to include some places of interest selected according to a predetermined criterion among the plurality of places of interest, or to surely include a point of interest selected according to a predetermined criterion among the plurality of places of interest. The predetermined criterion may include at least one among the distances between the places of interest and the screen region, the popularity of each of the places of interest, and the type of each of the places of interest. Otherwise, the predetermined criterion may be provided by providing the user terminals 200 with a plurality of criteria and receiving one of the plurality of criteria selected by the user terminals 200. For example, the screen region providing unit 112 may update the screen region to include a place of interest which is nearest to the current screen region, a place of interest which has the highest popularity, or a place of interest which has the highest relevance to the user's request.

The non-screen region information providing unit 113 updates and provides the non-screen region information, based on the updated screen region.

The updating and providing of the screen region and the non-screen region information may be repeatedly performed whenever the move command is received from the user terminal 200 displaying the screen region. The move command is not, however, limited to that transmitted from the user terminals 200, and may be generated according to various requests. For example, the move command may be generated by a processor included in the map service providing apparatus 110 or transmitted from an external device such as the user terminals 200.

When the move command is received from the user terminal 200, the move command may be generated from a signal for selecting the non-screen region information displayed in the screen region. For example, when a plurality of pieces of non-screen region information corresponding to a plurality of sub-regions is displayed in the screen region and a user selects one of the plurality of pieces of non-screen region information, a move command instructing to move the screen region to a location corresponding to the selected non-screen region information is generated and transmitted to the map service providing apparatus 110.

FIG. 3 is a flowchart of a map service providing method according to an exemplary embodiment.

The method described in FIG. 3 includes operations to be sequentially performed by the map service providing apparatus 110 of FIG. 2. Thus, although not described here, the above description of the elements illustrated in FIG. 2 is applicable to the flowchart of FIG. 3.

Referring to FIG. 3, in operation 31, the map output unit 110 of FIG. 2 outputs a map corresponding to a search request from one of the user terminals 200. In operation 32, the screen region providing unit 112 of FIG. 2 provides a screen region to be displayed on the screen of the user terminal 200 requesting the search request. In operation 33, the non-screen region providing unit 113 of FIG. 2 provides information regarding a point of interest included in a non-screen region to be displayed in the screen region.

### Second embodiment

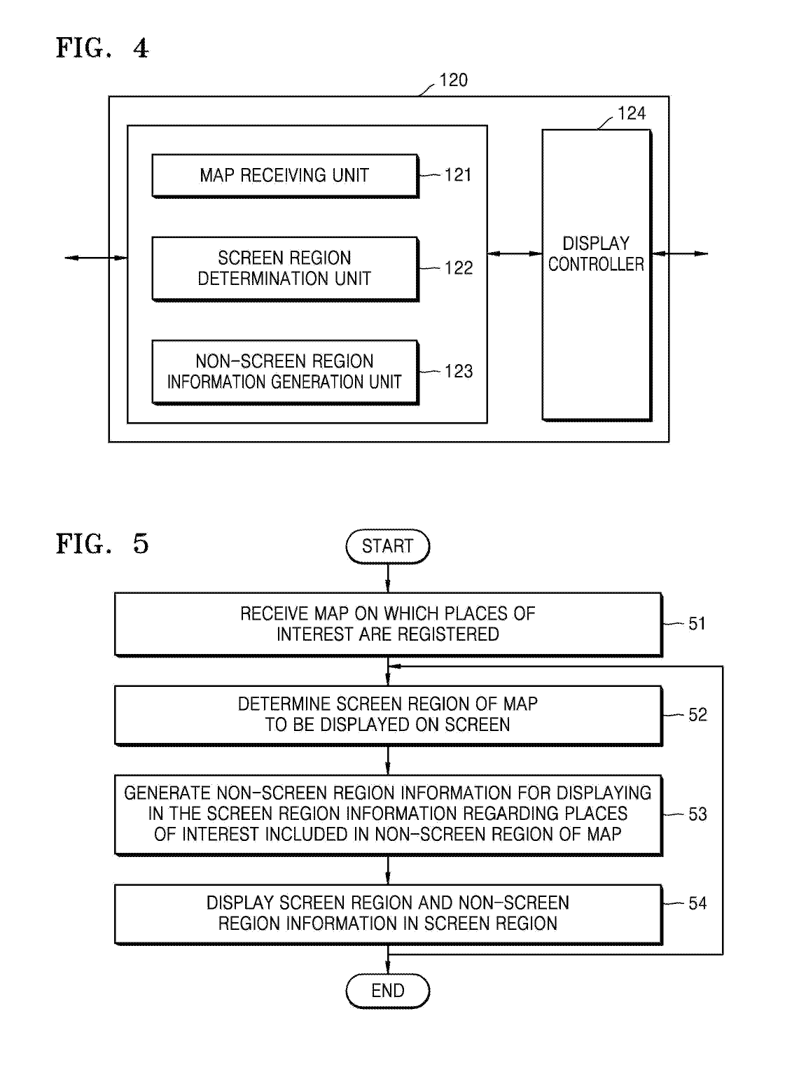

FIG. 4 is a block diagram of the display control device 120 included in the user terminals 200 of FIG. 1 according to an exemplary embodiment.

According to an exemplary embodiment, the display control device 120 may correspond to or include at least one processor. Thus, the display control device 120 may be driven while being included in another hardware device such as a microprocessor or a general-purpose computer system, or may be installed in the user terminals 200.

Only some elements of the display control device 120 related to the present embodiment are illustrated in FIG. 4 to prevent features of the present embodiment from being obscure. It would be apparent to those of ordinary skill in the art that the display control device 120 may further include other general elements.

Referring to FIG. 4, the display control device 120 includes a map receiving unit 121, a screen region determination unit 122, a non-screen region information generation unit 123, and a display controller 124. The map receiving unit 121, the screen region determination unit 122, the non-screen region information generation unit 123, and the display controller 124 may be different functions performed by the processor and identified for purpose of illustration, but the present invention is not limited thereto. For example, the map receiving unit 121, the screen region determination unit 122, the non-screen region information generation unit 123, and the display controller 124 may be separate physical components of the processor, and implemented by separate program codes, or they may be implemented by one integrated program code.

According to an exemplary embodiment, the map receiving unit 121 receives a map on which at least one point of interest is registered from the service providing server 100 of FIG. 1.

According to an exemplary embodiment, the screen region determination unit 122 determines at least a portion of the map to be a screen region. The screen region means a region of the entire map to be displayed on a display unit (not shown) of the user terminals 200.

According to an exemplary embodiment, the non-screen region information generation unit 123 generates non-screen region information by processing information regarding a point of interest included in a non-screen region which is a region of the map not including the screen region. The non-screen region information is displayed in the screen region to briefly describe information regarding the non-screen region that is not displayed on the screen of the user terminals 200.

According to an exemplary embodiment, the non-screen region information generation unit 123 generates the non-screen region information, based on at least one among the number, types, and locations of places of interest included in the non-screen region and the distances between the places of interest and the screen region. The non-screen region information may include, for example, at least one of the number of places of interest included in the non-screen region and the distance between a point of interest closest to the screen region among the places of interest and the screen region.

The non-screen region information generation unit 123 may further refer to the types of the places of interest when the non-screen region information is generated. The non-screen region information may include at least one of the number of places of interest included in the non-screen region and the distance between a point of interest closest to the screen region and the screen region, according to each of the types of the places of interest.

In one exemplary embodiment, the non-screen region may be divided into a plurality of sub-regions according to a predetermined criterion. The non-screen region information generation unit 123 may generate non-screen region information corresponding to each of the plurality of sub-regions.

In one exemplary embodiment, the display controller 124 displays on the display unit of the corresponding user terminal 200 the screen region determined by the screen region determination unit 122 and the non-screen region information determined by the non-screen region information generation unit 123. The non-screen region information may be displayed in the screen region. Otherwise, the non-screen region information may be displayed on an edge of the screen region.

According to an exemplary embodiment, the display controller 124 may display a plurality of pieces of non-screen region information generated in units of the plurality of sub-regions, in which the locations of the plurality of pieces of non-screen region information may be set to correspond to locations on the screen region corresponding to the plurality of sub-regions.

According to another exemplary embodiment, the display controller 124 may display the plurality of pieces of non-screen region information corresponding to the plurality of sub-regions, together with or in icons stored beforehand. The icons may be in the form of arrows provided to correspond to the plurality of sub-regions so as to face the plurality of sub-regions.

The display control device 120 recognizes an input signal that is input via the I/O device of the corresponding user terminal 200 to move the screen region in a state in which the screen region is displayed on the user terminal 200, and generates a move command based on the input signal. The move command is input to the screen region determination unit 122. The move command may be generated from an input signal instructing to select the non-screen region information or to select one of the plurality of pieces of non-screen region information corresponding to the plurality of sub-regions.

According to an exemplary embodiment, the screen region determination unit 122 newly determines a screen region based on the move command whenever the move command is received. For example, the screen region determination unit 122 may determine a screen region to include a point of interest corresponding to the non-screen region information selected according to the move command. A plurality of places of interest may correspond to the non-screen region information selected according to the move command. In this case, the screen region determination unit 122 determines a screen region to include all the plurality of places of interest, to include some places of interest selected according to a predetermined criterion among the plurality of places of interest, or to surely include a point of interest selected according to the predetermined criterion among the plurality of places of interest. The predetermined criterion may include at least one among the distances between the plurality of places of interest and the screen region, the popularity of each of the places of interest, and the types of the places of interest. Otherwise, the predetermined criterion may be set according to a user input instructing to select one of a plurality of criteria.

The non-screen region information generation unit 123 newly generates non-screen region information based on the newly determined screen region.

Generating of the screen region and the non-screen region information may be repeatedly performed whenever a move command generated according to a user input is received. The move command is not, however, limited to that generated according to a user input, and may be generated according to various methods. For example, the move command may be generated by a processor included in the corresponding user terminal 200 displaying the screen region or transmitted from an external device such as the service providing server 100.

When the move command is generated according to a user input, the move command may be generated according to a user input instructing to select the non-screen region information displayed in the screen region. For example, when a plurality of pieces of non-screen region information corresponding to the plurality of sub-regions are displayed in the screen region and a user selects one of the plurality of pieces of non-screen region information, a move command instructing to move the screen region to a location corresponding to the selected non-screen region information may be generated and input to the screen region determination unit 122.

FIG. 5 is a flowchart of a display control method according to an exemplary embodiment.

The method described in FIG. 5 includes operations to be sequentially performed by the display control device 120 of FIG. 4. Thus, although not described here, the above description of the elements of FIG. 4 is applicable to the flowchart of FIG. 5.

Referring to FIGS. 1, 4, and 5, in operation 51, the map receiving unit 121 receives a map on which a plurality of places of interest are registered from the service providing server 100. In operation 52, the screen region determination unit 122 determines a screen region of the map, which is received by the map receiving unit 121, to be displayed on the screen of the user terminal 200 requesting a search request. In operation 53, the non-screen region information generation unit 123 generates non-screen region information for displaying, in the screen region, information regarding places of interest included in a non-screen region which is a region of the map not including the screen region. In operation S54, the display controller 124 displays the screen region and the non-screen region information in the screen region. Operations S52 to 54 may be repeatedly performed whenever a move command instructing to change the screen region is received.

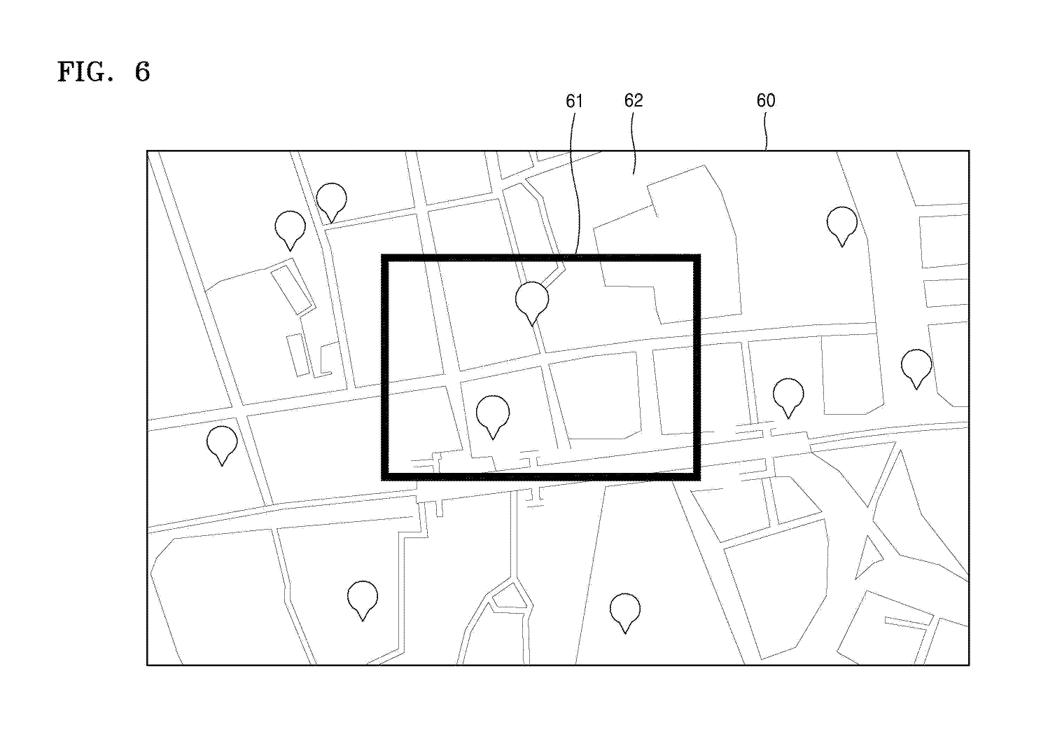

Examples of a map provided from a map service providing system according to an exemplary embodiment will be described with reference to FIGS. 6 to 11 below.

FIG. 6 illustrates a map 60 provided from a map service providing system according to an exemplary embodiment.

FIG. 6 illustrates the map 60 provided from the map service providing system, a screen region 61 displayed on the screen of one of the user terminals 200 of FIG. 1, and a non-screen region 62 which is a region of the map 60 not including the screen region 61.

Referring to FIG. 6, a plurality of regions of interest are present on the map 60, and pins pointing the plurality of regions of interest are displayed on the map 60. The locations of the plurality of regions of interest may be expressed using coordinates on the map 60. The plurality of regions of interest may be registered beforehand by a user or a manager of the service providing server 100 but is not limited thereto.

According to an exemplary embodiment, the map 60 of FIG. 6 may include a search result corresponding to a user's request, and the screen region providing unit 112 of FIG. 2 may provide the screen region 61 to include a point of interest corresponding to a search result. Similarly, the screen region determination unit 122 of FIG. 4 may determine the screen region 61 to include the point of interest corresponding to the search result.

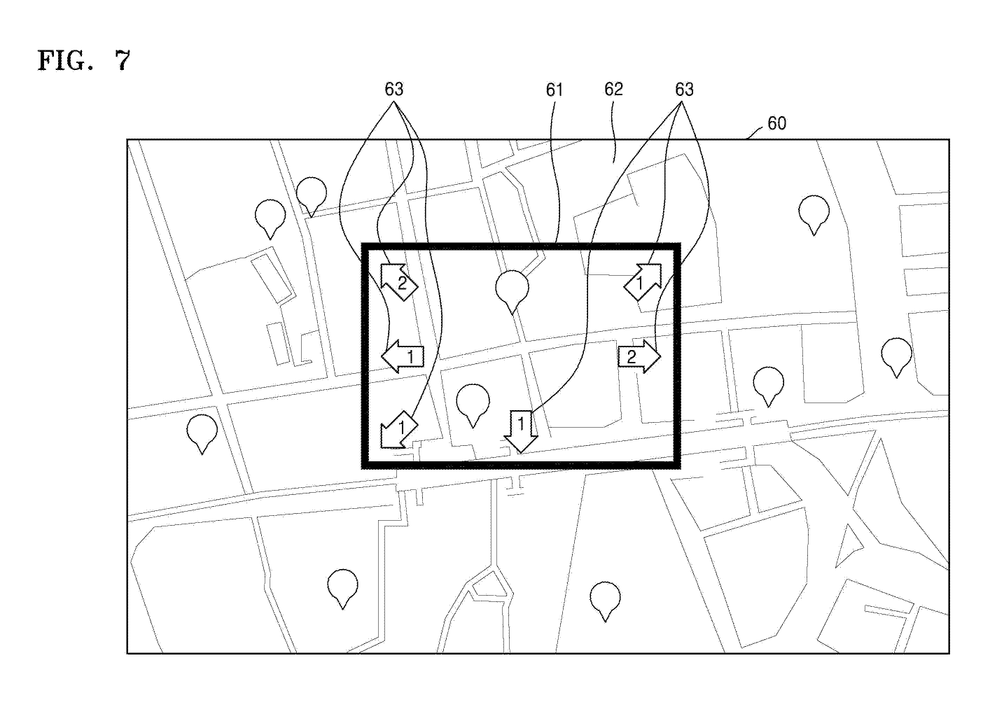

FIG. 7 illustrates the map 60 provided from a map service providing system according to another exemplary embodiment.

FIG. 7 illustrates the map 60 provided from the map service providing system, a screen region 61 displayed on the screen of one of the user terminals 200 of FIG. 1, and a non-screen region 62 which is a region of the map 60 not including the screen region 61. Non-screen region information 63 is displayed in the screen region 61.

As illustrated in FIG. 7, the non-screen region information 63 may include a number of places of interest included in the non-screen region 62. The number of places of interest indicated in the screen region 61 in each of various directions is displayed as the non-screen region information 63. The non-screen region information 63 may be displayed in arrow-type icons each representing one of the various directions. Although FIG. 7 illustrates a case in which the non-screen region information 63 represents the number of places of interest, exemplary embodiments are not limited thereto.

As illustrated in FIG. 7, a plurality of pieces of non-screen region information 63 may be displayed. For example, the non-screen region 62 may be divided into a plurality of sub-regions according to a predetermined criterion, and the plurality of pieces of non-screen region information 63 may be displayed with respect to the plurality of sub-regions, respectively. Each of the plurality of pieces of non-screen region information 63 may include the number of places of interest included in one of the plurality of sub-regions, and may be displayed in one of arrow-type icons displayed to point the plurality of sub-regions.

As illustrated in FIG. 7, the plurality of pieces of non-screen region information 63 may be arranged and displayed on an edge of the screen region 61. The locations on the screen region 61 on which the plurality of pieces of non-screen region information 63 are displayed, respectively, may be determined according to the locations of the plurality of sub-regions corresponding to the plurality of pieces of non-screen region information 63.

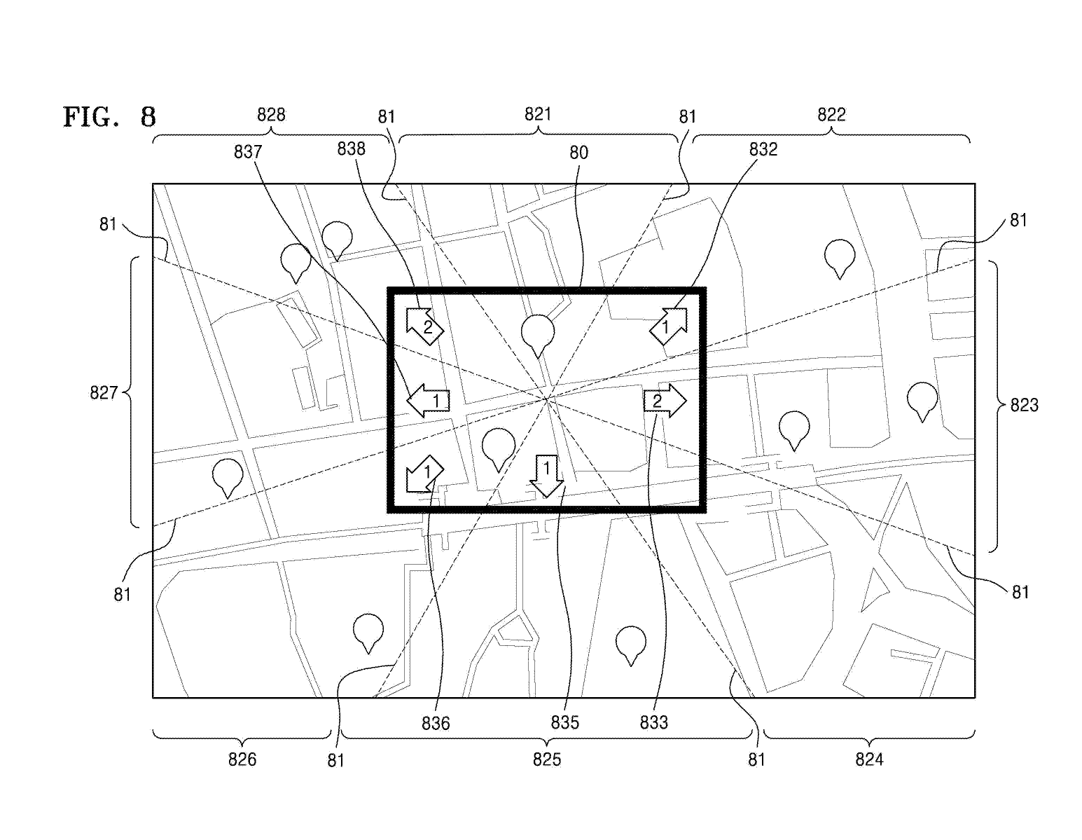

FIG. 8 illustrates a map provided from a map service providing system according to another exemplary embodiment.

According to an exemplary embodiment, a non-screen region may be divided into a plurality of sub-regions according to a predetermined criterion. Referring to FIG. 8, the non-screen region is divided into a plurality of sub-regions 821, 822, 823, 824, 825, 826, 827, and 828 by imaginary split lines 81.

Referring to FIG. 8, the split lines 81 are straight lines extending from a center of a screen region 80 and angles at which adjacent split lines 81 intersect each other are the same. However, exemplary embodiments are not limited thereto, and the split lines 81 may be determined according to various methods. For example, the non-screen region may be divided into a plurality of sub-regions according to another criterion without using the split lines 81.

Referring to FIG. 8, a plurality of pieces of non-screen region information corresponding to the plurality of sub-regions 821 to 828 are displayed in the screen region 80. In the embodiment of FIG. 8, each of the plurality of pieces of non-screen region information includes the number of places of interest included in one of the plurality of sub-regions 821 to 828. FIG. 8 illustrates the second non-screen region information 832 corresponding to the second sub-region 822, the third non-screen region information 833 corresponding to the third sub-region 823, the fifth non-screen region information 835 corresponding to the fifth sub-region 825, the sixth non-screen region information 836 corresponding to the sixth sub-region 826, the seventh non-screen region information 837 corresponding to the seventh sub-region 827, and the eighth non-screen region information 838 corresponding to the eighth sub-region 828. The plurality of pieces of non-screen region information are displayed on an edge of the screen region 80 to face the corresponding sub-regions thereof.

However, as illustrated in FIG. 8, non-screen region information is not displayed to correspond to all the plurality of sub-regions. When non-screen region information represents the number of places of interest included in a sub-region, non-screen region information may not be displayed with respect to a sub-region that does not include a point of interest. For example, the first sub-region 821 and the fourth sub-region 824 do not include a point of interest and thus non-screen region information corresponding to each of the first sub-region 821 and the fourth sub-region 824 is not displayed. However, exemplary embodiments are not limited thereto. For example, according to a modified example of the embodiment of FIG. 8, non-screen region information corresponding to the first sub-region 821 and the fourth sub-region 824 may be displayed to be ‘0’.

The non-screen region information providing unit 113 of FIG. 2 and the non-screen region information generation unit 123 of FIG. 4 may calculate the number of places of interest included in each of the sub-regions so as to generate non-screen region information by counting the number of places of interest included in each of the sub-regions.

For example, as illustrated in FIG. 8, when the non-screen region is divided into sub-regions according to a radiation angle with respect to the center of the screen region 80, a radiation angle of each of the sub-regions with respect to the screen region may be calculated using the coordinates of the screen region and the coordinates of the locations of the places of interest, and the places of interest may be determined to be included in the sub-region corresponding to the calculated radiation angle.

Although FIG. 8 illustrates eight sub-regions, the number of sub-regions is not limited to eight. Also, although FIG. 8 illustrates each of split lines as a straight line extending from a center of a region of interest, a method of drawing the split lines is not limited thereto. For example, split lines may be drawn horizontally or vertically with respect to a map and thus the non-screen region may be divided into sub-regions in the form of lattices.

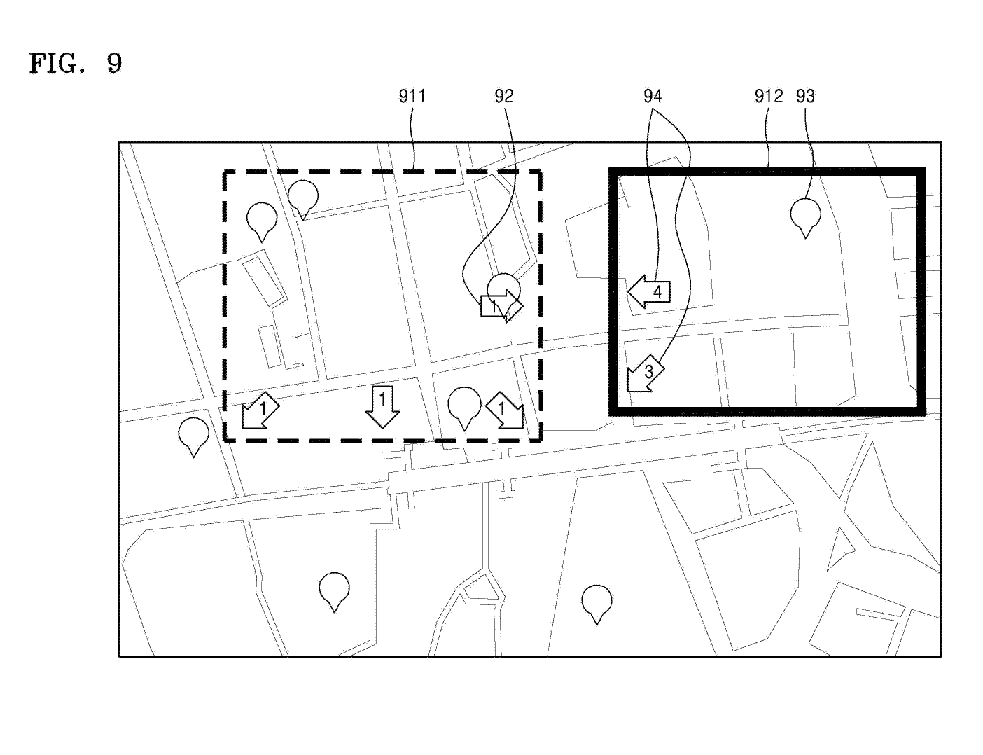

FIG. 9 is a diagram illustrating a method of changing a screen region on a map provided from the map service providing system of the present invention according to an exemplary embodiment.

When receiving a command instructing to change the screen region, the screen region providing unit 112 of FIG. 2 or the screen region determination unit 122 of FIG. 4 changes the screen region. Referring to FIG. 9, the screen region providing unit 112 or the screen region determination unit 122 switches a first screen region 911 to a second screen region 912 as the screen region to be displayed on the user terminal 200 that requested a search.

For example, when a user selects first non-screen region information 92 in a state in which the first screen region 911 is displayed on the user terminal 200, the screen region providing unit 112 or the screen region determination unit 122 may switch the first screen region 911 to the second screen region 912 so as to display on the screen a point of interest corresponding to the first non-screen region information 92 selected by the user.

The second screen region 912 may be set to include a point of interest 93 included in a sub-region corresponding to the first non-screen region information 92. That is, a user may select the first non-screen region information 92 in a desired direction to view a point of interest that is not displayed on the first screen region 911, and then the map service providing system may move the screen region to display the point of interest that the user wants to view.

FIG. 9 illustrates that one point of interest corresponds to the first non-screen region information 92 and the second screen region 912 is set to include this point of interest. According to an exemplary embodiment, when a plurality of places of interest correspond to non-screen region information selected by a user, the second screen region 912 may be set to include all, some, or one of the plurality of places of interest. When the second screen region 912 is set to include some or one of the plurality of places of interest, a criterion for selecting the some or one of the plurality of places of interest may be, but is not limited to, the distances to the plurality of places of interest or the popularities of the plurality of places of interest.

The user's selection of the first non-screen region information 92 may be performed using the I/O device of the corresponding user terminal 200, e.g., a touch panel. A move command input by a user may be generated by selecting non-screen region information as illustrated in FIG. 9 but is not limited thereto. For example, the move command may be generated when a user performs a gesture of move a screen by dragging the screen in a state in which the screen is clicked or a gesture of increasing or decreasing the size of the screen, etc.

Referring to FIG. 9, as the screen region is changed, the non-screen region is also updated. When the screen region is changed, the non-screen region is changed and a plurality of sub-regions included in the non-screen region are changed, thereby changing the non-screen region information. FIG. 9 illustrates updated non-screen region information 94 corresponding to the second screen region 912 when the first screen region 911 is switched to the second screen region 912.

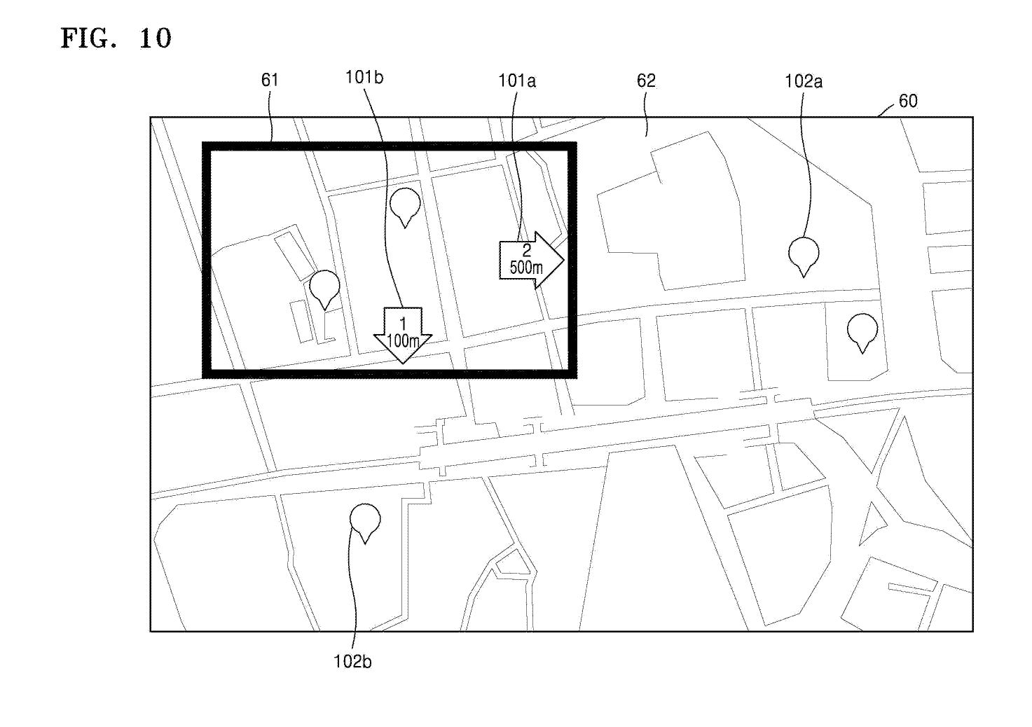

FIG. 10 is a diagram illustrating the map 60 provided from the map service providing system of the present invention according to another exemplary embodiment.

Referring to FIG. 10, non-screen region information 101a and 101b may each include the number of regions of interest and distances to the regions of interest. As described above, non-screen region information may include not only the number of places of interest included in a corresponding sub-region but also the distance to the point of interest closest to the screen region 61 among the places of interest included in the sub-region. Referring to FIG. 10, the first non-screen region information 101a includes information, e.g., 500 m, regarding a distance to a point of interest 102a closest to the screen region 61 among the places of interest included in the corresponding sub-region, and the second non-screen region information 101b includes information, e.g., 100 m, regarding a distance to a point of interest 102b closest to the screen region among the places of interest included in the corresponding sub-region.

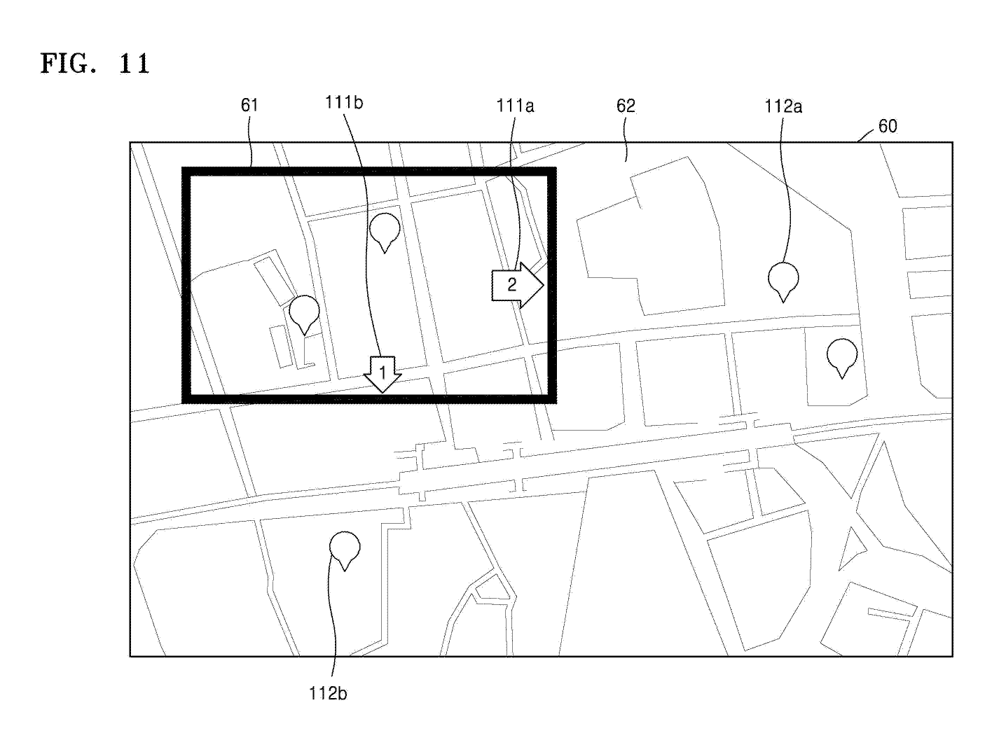

FIG. 11 is a diagram illustrating the map 60 provided from the map service providing system of the present invention according to another exemplary embodiment.

Referring to FIG. 11, non-screen region information 111a and 111b may be displayed differently according to content of non-screen region information. For example, the non-screen region information 111a and 111b may be displayed in icons, the sizes of which may be displayed differently according to the feature of the non-screen region information. Here, the “feature of the non-screen region information” should be understood to include the content of the non-screen region information, the type of sub-regions, the sizes of the sub-regions, the types of places of interest, the popularities of the places of interest, the accuracy of a search result according to a user's request, etc. For example, when a plurality of pieces of non-screen region information correspond to sub-regions divided from a non-screen region and each include the number of places of interest included in a corresponding sub region among the sub-regions, the plurality of pieces of non-screen region information may be displayed in different sizes according to the numbers of places of interest included in the corresponding sub-regions.

As illustrated in FIG. 11, the sizes of the icons in which the non-screen region information 111a and 111 b are displayed, respectively, may be different according to the numbers of the places of interest included in the respective non-screen region information 111a and 111 b. Although FIG. 11 illustrates that the size of each of the icons is proportional to the number of places of interest thereof, exemplary embodiments are not limited thereto. For example, only an icon in which a piece of non-screen region information corresponding to a sub-region having a largest number of places of interest is displayed may be displayed in a large size, and the other icons in which the other pieces of non-screen region information are displayed may be displayed in the same small size.

The displaying of the icons in different sizes is merely an example of a method of differently displaying the plurality of pieces of non-screen region information. For example, according to an exemplary embodiment, the plurality of pieces of non-screen region information may be displayed using other various methods (e.g., they may be displayed in different colors, in icons of different shapes, using different animation effects, etc) to be differentiated from one another.

Although not shown, places of interest may be classified as different categories according to the types thereof, and the numbers of places of interest displayed as the plurality of pieces of non-screen region information may be divided and displayed according to the categories. The numbers of places of interest classified according to a plurality of categories may be displayed as one piece of non-screen region information corresponding to one sub-region. For example, when places of interest are real estate on the market and are categorized as monthly rent, a key-money deposit, and for sale, non-screen region information may include the numbers of places of interest such that the number of places of interest are categorized as ‘monthly rent:2’, ‘a key-money deposit:5’, and ‘for sale:3’.

In one exemplary embodiment, a request to provide a map, which may be transmitted from any of the user terminals 200 to the service providing server 100, may be the same as a specific search word or be a request to return a map including a corresponding point of interest. For example, the request received from the user terminal 200 may include a query ‘bank’, and be a request to return a map including a point of interest corresponding to the query ‘bank’.

In one exemplary embodiment, a request to provide a map, which may be transmitted from any of the user terminals 200, may be a request to return a map including a point of interest included in a specific administrative district. For example, the request received from the user terminal 200 may include a query “Gangnam-gu, Seoul” and be a request to return a map including, as places of interest, real estate on the market corresponding to the query.

In the one or more of the above embodiments, the expression “places of interest” should be understood to generally include places registered in relation to coordinates on a map.

A method of providing a map service, a display control method and apparatus and a computer-readable recording medium thereof according to exemplary embodiments are capable of providing a map service screen contributing to user convenience.

According to the one or more of the above embodiments, information regarding regions of a map that are not displayed on a screen of a display unit may be processed and displayed on the screen and thus a user is able to obtain the information regarding the regions without move the screen, thereby increasing user convenience.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of providing a map service, the method comprising:
outputting, by a processor, a map on which at least one point of interest is registered;
providing, by the processor, a screen region to a user terminal, wherein the screen region is at least a region of the map to be displayed on a screen of the user terminal; and
generating, by the processor, non-screen region information by processing information regarding the at least one point of interest included in a non-screen region, and providing the user terminal with the non-screen region information such that the non-screen region information is displayed in the screen region, wherein the non-screen region is a region of the map not including the screen region.

2. The method of claim 1, wherein the providing of the non-screen region information comprises generating the non-screen region information based on at least one among a number of the at least one point of interest included in the non-screen region, a type of the at least one point of interest, a location of the at least one point of interest, and a distance between the at least one point of interest and the screen region.

3. The method of claim 2, wherein the non-screen region information comprises at least one of:
the number of the at least one point of interest included in the non-screen region; and
a distance between the screen region and a point of interest closest to the screen region among the at least one point of interest included in the non-screen region.

4. The method of claim 2, wherein the providing of the non-screen region information comprises generating the non-screen region information based on the number, type, and location of the at least one point of interest included in the non-screen region,
wherein the generated non-screen region information comprises at least one of:
a number of places of interest included in the non-screen region according to a type of each of the places of interest; and
a distance between the screen region and a point of interest closest to the screen region among the places of interest included the non-screen region according to a type of each of the places of interest.

5. The method of claim 1, wherein the non-screen region comprises a plurality of sub-regions divided from the non-screen region according to a preset criterion, and
the providing of the non-screen region information comprises generating and providing, by the processor, a plurality of pieces of non-screen region information respectively corresponding to the plurality of sub-regions.

6. The method of claim 5, wherein the plurality of pieces of non-screen region information respectively corresponding to the plurality of sub-regions are provided to be displayed at locations on the screen region corresponding to the plurality of pieces of sub-regions.

7. The method of claim 5, wherein the plurality of pieces of non-screen region information respectively corresponding to the plurality of sub-regions are displayed together with icons displayed to respectively face the plurality of pieces of sub-regions.

8. The method of claim 7, wherein the icons are in the form of arrows displayed to respectively face the plurality of sub-regions corresponding to the icons, and
the plurality of pieces of non-screen region information are displayed in the icons.

9. The method of claim 1, wherein the non-screen region information is provided to be displayed on an edge of the screen region.

10. The method of claim 1, wherein the non-screen region information is displayed in an arrow-type icon displayed to face the non-screen region.

11. The method of claim 1, wherein the providing of the screen region and the providing of the non-screen region information are repeatedly performed whenever a move command instructing to move the screen region is received from the user terminal,
wherein the providing of the screen region comprises determining the screen region based on the move command.

12. The method of claim 11, wherein the move command is generated in response to a signal for selecting the non-screen region information displayed in the screen region.

13. The method of claim 12, wherein the non-screen region comprises a plurality of sub-regions divided from the non-screen region according to a preset criterion,
the providing of the non-screen region information comprises generating and providing a plurality of pieces of non-screen region information respectively corresponding to the plurality of sub-regions,
the move command is generated in response to a signal for selecting one of the plurality of pieces of non-screen region information respectively corresponding to the plurality of sub-regions, and
the providing of the screen region comprises determining the screen region to include at least some places of interest selected according to a predetermined criterion among at least one point of interest corresponding to the non-screen region information selected according to the move command.

14. A display control method comprising:
receiving, by the processor, a map on which at least one point of interest is registered;
determining, by the processor, at least a region of the map as a screen region; and
generating, by the processor, non-screen region information by processing information regarding the at least one point of interest included in a non-screen region, wherein the non-screen region is a region of the map not including the screen region; and
displaying, by the processor, the screen region and the non-screen region information in the screen region.

15. The display control method of claim 14, wherein the generating of the non-screen region information comprises generating, by the processor, the non-screen region information based on a number of the at least one point of interest included in the non-screen region, a type of the at least one point of interest, location of the at least one point of interest, and a distance between the screen region and the at least one point of interest.

16. The display control method of claim 14, wherein the non-screen region comprises a plurality of sub-regions divided from the non-screen region according to a preset criterion,
the generating of the non-screen region information comprises generating a plurality of pieces of non-screen region information respectively corresponding to the plurality of sub-regions, and
the displaying of the screen region and the non-screen region information comprises displaying the plurality of pieces of non-screen region information respectively corresponding to the plurality of sub-regions on locations on the screen region that respectively correspond to the plurality of the sub-region.

17. The display control method of claim 16, wherein the displaying of the screen region and the non-screen region information comprises displaying, by the processor, the plurality of pieces of non-screen region information respectively corresponding to the plurality of sub-regions, together with icons displayed to respectively face the plurality of sub-regions.

18. The display control method of claim 14, wherein the displaying of the screen region and the non-screen region information comprises displaying the non-screen region information on an edge of the screen region.

19. The display control method of claim 14, wherein the displaying of the screen region and the non-screen region information comprises displaying, by the processor, the non-screen region information in arrow-type icons displayed to face the non-screen region.

20. The display control method of claim 14, wherein the determining of the screen region, the generating of the non-screen region information, and the displaying of the screen region and the non-screen region information are repeatedly performed whenever a move command instructing to move the screen region is recognized,
the determining of the screen region comprises determining the screen region based on the move command, and
the move command is generated through a gesture of selecting and dragging the screen region, a gesture of increasing or decreasing a size of the screen region, or a gesture of selecting the non-screen region information.
